(19) United States
(12) Patent Application Publication
(10) Pub. No.: US 2026/0051605 A1
(43) Pub. Date: Feb. 19, 2026

(54) BATTERY PACK

(71) Applicants: HYUNDAI MOTOR COMPANY, Seoul (KR); KIA CORPORATION, Seoul (KR)

(72) Inventors: Sang Gu Kang, Hwaseong-si (KR); Min Kyeong Kang, Hwaseong-si (KR)

(73) Assignees: HYUNDAI MOTOR COMPANY, Seoul (KR); KIA CORPORATION, Seoul (KR)

(21) Appl. No.: 19/244,738

(22) Filed: Jun. 20, 2025

(30) Foreign Application Priority Data
Aug. 16, 2024 (KR) 10-2024-0109889
Dec. 31, 2024 (KR) 10-2024-0202721

(51) Int. Cl. H01M 50/291; H01M 10/48; H01M 50/233; H01M 50/276; H01M 50/293; H01M 50/507

(52) U.S. Cl. CPC H01M 50/291; H01M 10/48; H01M 50/233; H01M 50/276; H01M 50/293; H01M 50/507

(57) ABSTRACT

A battery pack includes a pair of battery modules. Each battery module includes a battery cell and a busbar electrically connected to the battery cell. The battery pack further includes a pack housing that extends to cover portions of peripheries of the pair of battery modules, a pack cover that is coupled with the pack housing and that covers one side of the battery modules, and a partition wall member disposed between the pair of battery modules and located between the busbar and the pack cover to cover the busbar.

### CROSS-REFERENCE TO RELATED APPLICATION(S)

This application claims the benefit of priority to Korean Patent Application No. 10-2024-0202721, filed in the Korean Intellectual Property Office on Dec. 31, 2024, and Korean Patent Application No. 10-2024-0109889, filed in the Korean Intellectual Property Office on Aug. 16, 2024, and the entire contents of which are incorporated herein by reference.

### TECHNICAL FIELD

The present disclosure relates to a battery pack.

### BACKGROUND

In recent years, research and development on electric vehicles, which are environmentally-friendly vehicles, has grown as concerns regarding the environment and oil resource depletion has increased.

An electric vehicle, which is a vehicle powered by electricity, may include a battery pack. The battery pack may include a battery module including a plurality of battery cells.

A plurality of battery modules may be mounted in the battery pack, and each of the plurality of battery modules may include a battery cell and a busbar electrically connected with the battery cell.

The busbar may be exposed outside the battery module. In this case, due to conductive foreign matter resulting from a fire in the battery cell, a short circuit may occur between the busbar and other components adjacent to the busbar.

When the short circuit occurs between the busbar and the other components adjacent to the busbar, thermal runaway in the battery pack may be accelerated, and therefore there is a growing desire for a structure capable of preventing the phenomenon.

### SUMMARY

The present disclosure addresses the above-mentioned problems occurring in the prior art and provides improvements over the prior art.

An aspect of the present disclosure provides a battery pack for preventing a short circuit (e.g., phenomenon) occurring between a busbar and other components adjacent to the busbar.

The technical problems to be addressed by the present disclosure are not limited to the aforementioned problems, and any other technical problems not mentioned herein will be understood from the following description by those skilled in the art to which the present disclosure pertains.

According to an aspect of the present disclosure, a battery pack includes a pair of battery modules. The pair of battery modules includes a first battery module and a second battery module. Each battery module includes a battery cell and a busbar electrically connected to the battery cell. The first battery module includes a first battery cell and a first busbar, and the second battery module includes a second battery cell and a second busbar. The battery pack further includes a pack housing that extends to cover portions of peripheries of the pair of battery modules, a pack cover that is coupled with the pack housing and that covers one side of the battery modules, and a partition wall member disposed between the first battery module and the second battery module. The partition wall member is disposed between the pack cover and the first busbar to cover the first busbar, and is disposed between the pack cover and the second busbar to cover the second busbar.

The partition wall member may include a partition wall body provided between the first busbar and the second busbar and a cover body that extend from the partition wall body and cover the first busbar and the second busbar, respectively.

The cover body may be disposed between the first busbar and the second busbar and the pack cover.

The cover body may include a pair of cover bodies including a first cover body and a second cover body. The partition wall body may include a first partition wall body connected with the first cover body and a second partition wall body connected with the second cover body.

The first partition wall body and the second partition wall body may be attached (e.g., to each other).

The partition wall body may extend in a direction between the first battery module and the second battery module. The first cover body may be a plurality of first cover bodies, and the second cover body may be a plurality of second cover bodies. The plurality of first cover bodies may be spaced apart in the direction, and the plurality of second cover bodies may be spaced apart in the direction.

An angle between the partition wall body and the cover body may be obtuse angles.

An angle between the partition wall body and the cover body may be (e.g., about) 95 degrees.

The first battery modules may further include a first sensing assembly formed on a side in a lengthwise direction of the first battery cell, and the second battery module may further include a second sensing assembly formed on a side in a lengthwise direction of the second battery cell.

The partition wall member may further include a buffer pad attached to a surface of the partition wall body that faces at least one of the first sensing assembly or the second sensing assembly. The buffer pad may include rubber.

The partition wall member may further include a sealing pad that is disposed between the cover body and the pack cover.

The partition wall may seal a space between the cover body and the pack cover.

The sealing pad may include rubber.

The pack housing may include a base plate that supports the first battery modules and the second battery module and a cross member that is supported by the base plate and that extends (e.g., through) between the first battery module and the second battery module. The partition wall member may be supported by the cross member.

The cross member may include a longitudinal cross member that extends in a lengthwise direction of the battery pack and a transverse cross member that extends in a direction crossing the longitudinal cross member. The partition wall member may be supported by the transverse cross member.

The battery pack may further include a fixing member that fixes (e.g., couples) the base plate and the pack cover. The pack housing may further include a fixed guide member through which the fixing member passes. The partition wall member may include a cover body that is provided between the first busbar and the second busbar and that has a guide member cover area with a curvature to cover the fixed guide member.

The battery pack may further include a longitudinal busbar disposed parallel to the longitudinal cross member, and a busbar cover between the longitudinal busbar and the pack cover to cover the longitudinal busbar. The partition wall member may include a partition wall body provided between the first busbar and the second busbar, and a longitudinal cover body that extends from one end of the partition wall body in a lengthwise direction and covers the busbar cover.

The partition wall body may be formed of MICA.

The cover body may be formed of MICA.

### BRIEF DESCRIPTION OF THE DRAWINGS

The above and other objects and features of the present disclosure will be more apparent from the following detailed description taken in conjunction with the accompanying drawings:

FIG. 1 is a plan view of components other than a pack cover of a battery pack according to an example embodiment of the present disclosure;

FIG. 2 is a perspective view of a battery module according to an example embodiment of the present disclosure;

FIG. 3 is an enlarged perspective view of battery modules and a first partition wall member according to an example embodiment of the present disclosure;

FIG. 4 is a perspective view of the first partition wall member according to an example embodiment of the present disclosure;

FIG. 5 is a side view of a partition wall body and a cover body of the first partition wall member according to an example embodiment of the present disclosure;

FIG. 6 is a side view illustrating a state in which a first partition wall body and a second partition wall body of the first partition wall member are attached according to an example embodiment of the present disclosure;

FIG. 7 is a plan view of a partition wall member disposed between a pair of battery modules according to an example embodiment of the present disclosure;

FIG. 8 is a vertical sectional view of the components other than the pack cover of the battery pack illustrated in FIG. 1;

FIG. 9 is a perspective view of a second partition wall member according to an example embodiment of the present disclosure; and

FIG. 10 is an enlarged perspective view of a pair of battery modules and the second partition wall member according to an example embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of known features or functions may not be included to prevent obscuring the gist of the present disclosure.

In describing the components of the embodiment according to the present disclosure, terms such as first, second, “A”, “B”, (a), (b), and the like may be used. These terms are intended to distinguish one component from another component, and the terms do not limit the nature, sequence, or order of the components. Unless otherwise provided, all terms used herein, including technical or scientific terms, have meanings as those generally understood by those skilled in the art to which the present disclosure pertains. Such terms as those provided in a generally used dictionary are to be interpreted as having meanings the same or similar to the contextual meanings in the relevant field of art, and are not to be interpreted as having ideal or excessively formal meanings unless provided as having such in the present application.

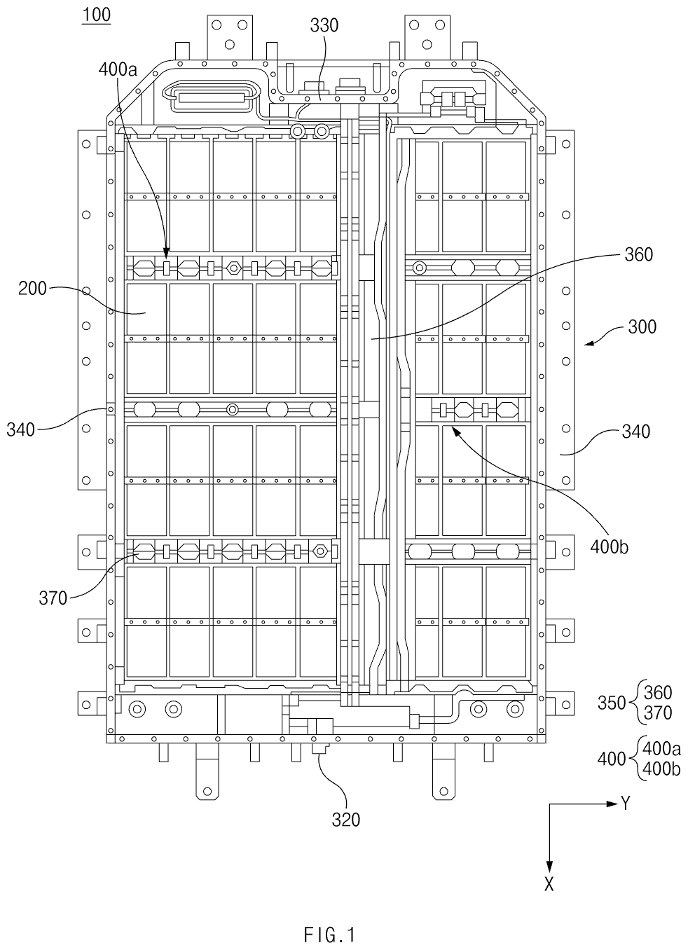

Hereinafter, embodiments of the present disclosure will be described in detail with reference to FIGS. 1 to 10. Hereinafter, a first direction may be an X direction (a front direction) or a direction opposite to the X direction (a rear direction), a second direction may be a Y direction (a left direction) or a direction opposite to the Y direction (a right direction), and a third direction may be a Z direction (an upper direction) or a direction opposite to the Z direction (a lower direction). Here, the first direction may be an overall-length direction of an electric vehicle, and the second direction may be a width direction of the electric vehicle.

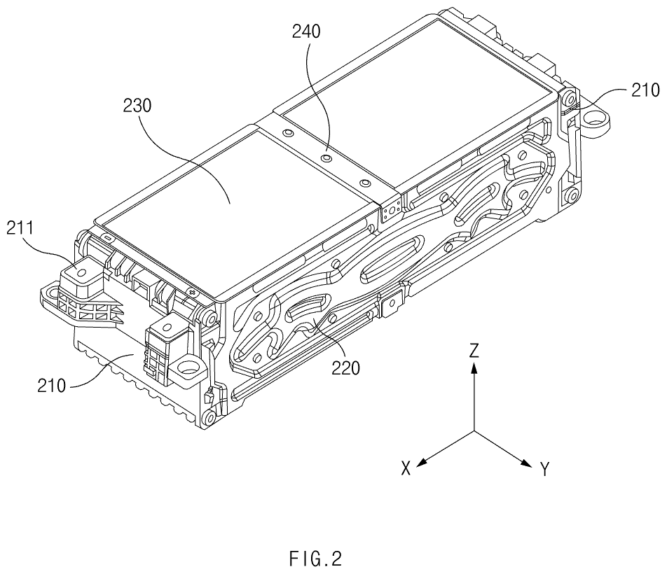

FIG. 1 is a plan view of components, other than a pack cover, of a battery pack according to an example embodiment of the present disclosure. FIG. 2 is a perspective view of a battery module according to an example embodiment of the present disclosure.

Referring to FIGS. 1 and 2, the battery pack 100 may include a plurality of battery modules 200, a pack housing 300, and the pack cover 500.

The plurality of battery modules 200 may be mounted in the pack housing 300. The plurality of battery modules 200 may be arranged side by side in the pack housing 300 in the first direction (the X direction or the direction opposite to the X direction) and the second direction (the Y direction or the direction opposite to the Y direction).

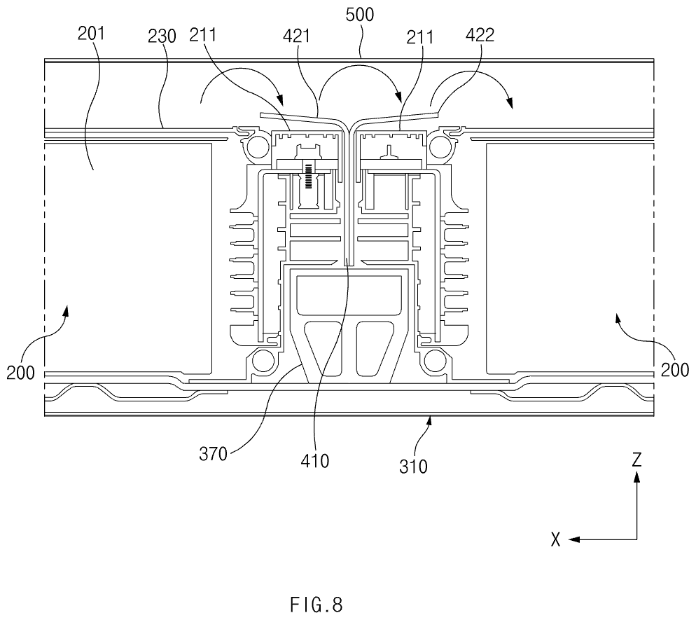

As illustrated in FIG. 2, each of the battery modules 200 may include a plurality of battery cells 201 (refer to FIG. 8), sensing assemblies 210, and a pair of end plates 220.

The battery cells 201 may extend in the first direction (the X direction or the direction opposite to the X direction) and may be stacked in the second direction (the Y direction or the direction opposite to the Y direction). The pair of end plates 220 may be provided on opposite sides of the plurality of battery cells 201 in the second direction (the Y direction or the direction opposite to the Y direction).

The pair of end plates 220 may press the plurality of battery cells 201 provided between the pair of end plates 220.

The sensing assemblies 210 may be formed on opposite sides in the lengthwise direction of the battery cells 201. The plurality of battery cells 201 may be electrically connected to busbars 211 of the sensing assemblies 210. The busbars 211 may be exposed outside the battery module 200 in the lengthwise direction of the battery module 200.

The battery module 200 may include a module cover 230 that covers (e.g., at least) one side of the battery cells 201 in the third direction (the Z direction) and a clamp member 240 that presses the pair of end plates 220 toward each other.

The pack housing 300 may be formed to surround portions of the peripheries of the plurality of battery modules 200.

The pack housing 300 may include a base plate 310 (refer to FIG. 8) that supports the plurality of battery modules 200, and a front member 320 and a rear member 330 that are coupled to opposite end areas of the base plate 310 in the first direction.

The pack housing 300 may include a pair of side members 340 coupled to opposite end areas of the base plate 310 in the second direction (the Y direction or the direction opposite to the Y direction).

The front member 320 may cover areas of the plurality of battery modules 200 that face toward one side in the first direction (the X direction). The rear member 330 may cover areas of the plurality of battery modules 200 that face toward an opposite side in the first direction (the direction opposite to the X direction).

The pair of side members 340 may cover areas of the plurality of battery modules 200 that face toward opposite sides in the second direction (the Y direction or the direction opposite to the Y direction).

The pack cover 500 may be coupled to the front member 320, the rear member 330, and the pair of side members 340 of the pack housing 300. The pack cover 500 may be coupled with the pack housing 300 and may cover one side of the plurality of battery modules 200 in the third direction (the Z direction).

The pack housing 300 may include a cross member 350 supported by the base plate 310. The cross member 350 may separate the plurality of battery modules 200 from each other. The cross member 350 may extend between a pair of battery modules 200 spaced apart from each other.

The cross member 350 may include longitudinal cross members 360 extending between the front member 320 and the rear member 330 in the first direction (the X direction or the direction opposite to the X direction) and transverse cross members 370 extending between one of the pair of side members 340 and the longitudinal cross members 360 in the second direction (the Y direction or the direction opposite to the Y direction).

Each of the longitudinal cross members 360 may extend (e.g., through) between a pair of battery modules 200 spaced apart from each other in the second direction (the Y direction or the direction opposite to the Y direction) among the plurality of battery modules 200. The longitudinal cross member 360 may extend in the lengthwise direction of the battery pack 100.

Each of the transverse cross members 370 may extend (e.g., through) between a pair of battery modules 200 spaced apart from each other in the first direction (the X direction or the direction opposite to the X direction) among the plurality of battery modules 200. The transverse cross member 370 may extend in a direction perpendicular to the longitudinal cross member 360.

A high-voltage cable or a longitudinal busbar 361 may be provided on one side of the longitudinal cross member 360 in the third direction (the Z direction). The busbar 211 of the battery module 200 may be provided on one side of the transverse cross member 370 in the third direction (the Z direction).

Meanwhile, a short circuit (e.g., phenomenon) may occur between the busbar 211 and other components adjacent to the busbar 211. When the short circuit (e.g., phenomenon) occurs between the busbar 211 and the other components adjacent to the busbar 211, a thermal runaway phenomenon may occur inside the battery pack 100.

Accordingly, for the stability of the battery pack 100, it is useful to prevent the short circuit (e.g., phenomenon) between the busbar 211 and the other components adjacent to the busbar 211. To achieve this, the battery pack 100 according to an example embodiment of the present disclosure may include partition wall members 400.

The partition wall members 400 may be supported by the transverse cross members 370. Each of the partition wall members 400 may be disposed between a pair of battery modules 200 spaced apart from each other in the first direction (the X direction or the direction opposite to the X direction) among the plurality of battery modules 200.

The partition wall member 400 may be disposed between the pair of battery modules 200 spaced apart from each other in the first direction (the X direction or the direction opposite to the X direction) among the plurality of battery modules 200.

The partition wall member 400 may separate the pair of battery modules 200 spaced apart from each other in the first direction (the X direction or the direction opposite to the X direction) among the plurality of battery modules 200 and may be located between the busbars 211 and the pack cover 500 to cover the busbars 211.

The partition wall members 400 may include first partition wall members 400a and second partition wall members 400b having different shapes based on the longitudinal cross members 360.

The first partition wall members 400a and the second partition wall members 400b may be disposed on opposite sides of the longitudinal cross members 360. The second partition wall members 400b may be disposed on one side of the longitudinal cross members 360 in the second direction (the Y direction), and the first partition wall members 400a may be disposed on an opposite side of the longitudinal cross members 360 in the second direction (the Y direction).

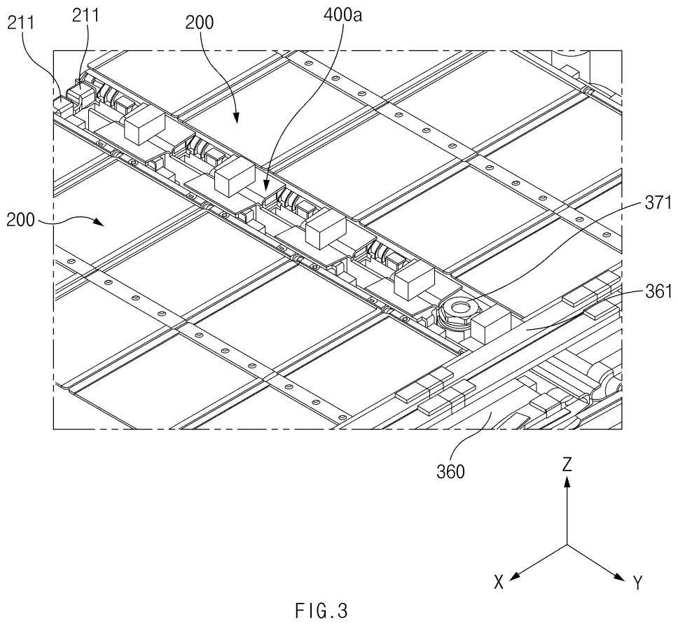

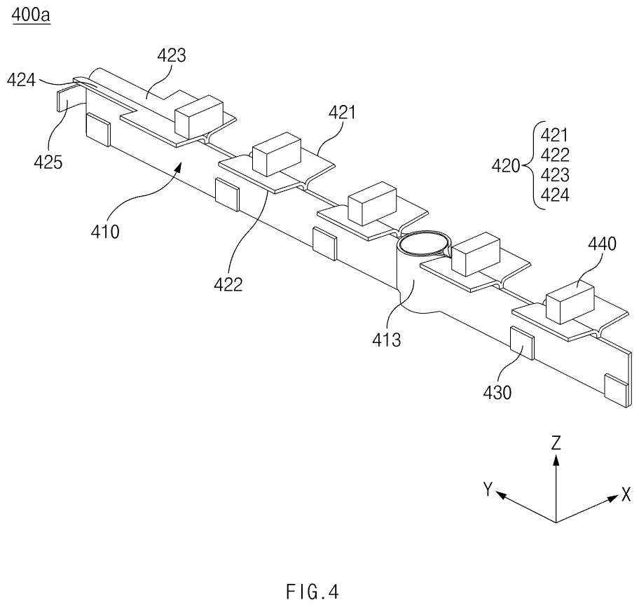

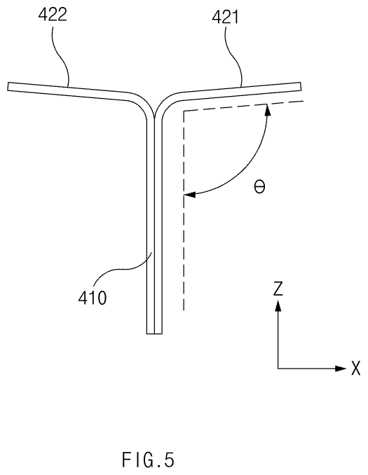

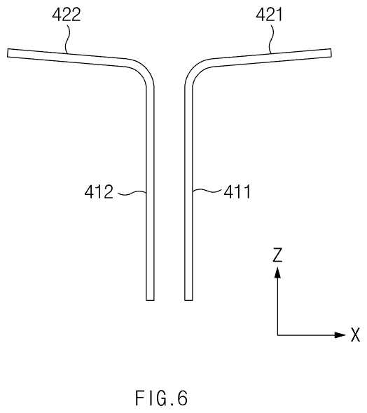

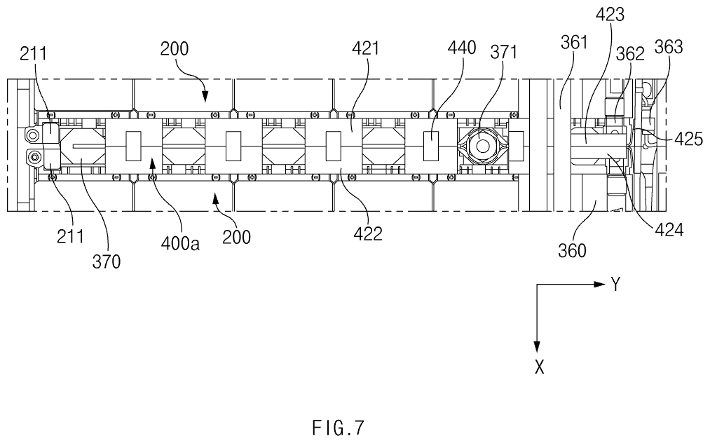

FIG. 3 is an enlarged perspective view of the battery modules and the first partition wall member according to an example embodiment of the present disclosure. FIG. 4 is a perspective view of the first partition wall member according to an example embodiment of the present disclosure. FIG. 5 is a side view of a partition wall body and a cover body of the first partition wall member according to an example embodiment of the present disclosure. FIG. 6 is a side view illustrating a state in which a first partition wall body and a second partition wall body of the first partition wall member are attached according to an example embodiment of the present disclosure. FIG. 7 is a plan view of a partition wall member disposed between a pair of battery modules according to an example embodiment of the present disclosure. FIG. 8 is a vertical sectional view of the (e.g., remaining) components other than the pack cover of the battery pack illustrated in FIG. 1.

Referring to FIGS. 3 to 8, the first partition wall member 400a may include a partition wall body 410 provided between a pair of busbars 211 and a cover body 420 that extend from the partition wall body 410 and cover the pair of busbars 211.

The partition wall body 410 may extend in the second direction (the Y direction or the direction opposite to the Y direction) between a pair of battery modules 200 spaced apart from each other in the first direction (the X direction or the direction opposite to the X direction).

The partition wall body 410 may be supported by the transverse cross member 370 and may extend such that the second direction (the Y direction or the direction opposite to the Y direction) corresponds to the lengthwise direction.

The cover body 420 may be disposed between the busbars 211 and the pack cover 500 and may cover one side of the busbars 211 in the third direction (the Z direction).

The cover body 420 may include a first cover body 421 and a second cover body 422 that extend from one end of the partition wall body 410 that faces toward one side in the third direction (the Z direction).

The first cover body 421 and the second cover body 422 may extend from the partition wall body 410 to face in opposite directions.

Each of the first cover body 421 and the second cover body 422 may be provided in plural. The plurality of first cover bodies 421 may be spaced apart from each other in the lengthwise direction of the partition wall body 410. The plurality of second cover bodies 422 may be spaced apart from each other in the lengthwise direction of the partition wall body 410.

The plurality of first cover bodies 421 may cover a plurality of busbars 211, and the plurality of second cover bodies 422 may cover a plurality of busbars 211. One first cover body 421 and one second cover body 422 may cover a pair of busbars 211 separated from each other by the partition wall body 410.

Meanwhile, as illustrated in FIG. 4, the first partition wall member 400a may further include a buffer pad 430 and a sealing pad 440.

The buffer pad 430 may be attached to one surface of the partition wall body 410 that faces the battery module 200. In more detail, the buffer pad 430 may be attached to one surface of the partition wall body 410 that faces the sensing assembly 210.

When the first partition wall member 400a is mounted between the pair of battery modules 200 spaced apart from each other in the first direction (the X direction or the direction opposite to the X direction), a pair of buffer pads 430 facing the pair of battery modules 200 may be brought into contact with the sensing assemblies 210 of the pair of battery modules 200, and accordingly the position of the first partition wall member 400a may be guided.

The buffer pads 430 may be formed of rubber (e.g., EPDM or ethylene propylene rubber). Accordingly, even though the first partition wall member 400a is brought into contact with the sensing assemblies 210, the sensing assemblies 210 may not be damaged.

The separation distance between the sensing assemblies 210 and the partition wall body 410 may be maintained by the buffer pads 430, and thus the structural safety of the battery pack 100 may be improved.

The sealing pad 440 may be disposed on the cover body 420. In other words, the sealing pad 440 may be disposed between the cover body 420 and the pack cover 500 and may seal the space between the cover body 420 and the pack cover 500.

The sealing pad 440 may also be formed of rubber (e.g., EPDM or ethylene propylene rubber), and therefore even though the pack cover 500 makes contact with the sealing pad 440, the pack cover 500 or the first partition wall member 400a may be prevented from being damaged.

At the same time, the separation distance between the pack cover 500 and the cover body 420 may be maintained by the sealing pad 440 so that the robustness of the battery pack 100 may be secured. Due to this, even though an external force is applied to the battery pack 100, noise may not occur, and thus user satisfaction may be improved.

As illustrated in FIG. 5, the angle (e.g., θ) between the partition wall body 410 and the cover body 420 may be an obtuse angle. The angle between the partition wall body 410 and the cover body 420 may be about 95 degrees.

According to this structure, the partition wall member 400 may be prevented from being damaged in a process in which the cover body 420 is bent from the partition wall body 410, and thus the productivity may be improved.

As illustrated in FIG. 6, the partition wall body 410 may include the first partition wall body 411 and the second partition wall body 412. The first partition wall body 411 may be connected with the first cover body 421, and the second partition wall body 412 may be connected with the second cover body 422.

The first partition wall body 411 may be integrally formed with the first cover body 421, and the second partition wall body 412 may be integrally formed with the second cover body 422. The first cover body 421 may be bent from the first partition wall body 411 and the second cover body 422 may be bent from the second partition wall body 412.

The first partition wall body 411 and the second partition wall body 412 may be attached (e.g., to each other) by an adhesive. However, without being limited thereto, the first partition wall body 411, the second partition wall body 412, the first cover body 421, and the second cover body 422 may be integrally formed.

As illustrated in FIG. 4, the partition wall body 410 may include a pair of guide member covers (e.g., pair of guide member cover areas) 413 having curvatures in opposite directions from the first partition wall body 411 and the second partition wall body 412.

The battery pack 100 may further include a fixing member (not illustrated) that passes through the pack cover 500, the first partition wall member 400a, and the base plate 310 and the fixing member fixes (e.g., couples) the pack cover 500, the base plate 310, and the first partition wall member 400a after the pack cover 500 is coupled with the pack housing 300. The fixing member may pass through the transverse cross member 370 (refer to FIG. 1) to fix (e.g., couple) the transverse cross member 370 (e.g., together) with the base plate 310 and the pack cover 500.

The pack housing 300 may include a fixed guide member 371 through which the fixing member passes. The fixed guide member 371 may have a hole that extends in the third direction (the Z direction or the direction opposite to the Z direction).

The pair of guide member covers 413 may have a curvature to cover the fixed guide member 371.

According to this example structure, although a fire may occur in the battery module 200, the fire may be prevented from spreading to the fixed guide member 371 formed of metal (e.g., aluminum), and thus safety may be improved.

The first partition wall member 400a may include a third cover body 423 and a fourth cover body 424 that are bent from the partition wall body 410 and that have a shape different from the shapes of the first and second cover bodies 421 and 422.

The third cover body 423 may be bent from one end of the first partition wall body 411 that faces toward one side in the third direction (the Z direction), and the fourth cover body 424 may be bent from one end of the second partition wall body 412 that faces toward one side in the third direction (the Z direction). The third cover body 423 and the fourth cover body 424 may be bent from the first partition wall body 411 and the second partition wall body 412 in opposite directions, respectively.

The third cover body 423 and the fourth cover body 424 may be formed on an area of the first partition wall member 400a that faces toward the longitudinal cross member 360 of the battery pack 100. The third cover body 423 and the fourth cover body 424 may have the shape of “T” when viewed at a distance from one side in the third direction (the Z direction).

The first partition wall member 400a may further include a longitudinal cover body 425 bent from one end of the partition wall body 410 in the lengthwise direction of the partition wall body 410. The longitudinal cover body 425 may be formed on one side of the first partition wall member 400a adjacent to the longitudinal cross member 360.

The battery pack 100 may include a longitudinal busbar 361 disposed parallel to the longitudinal cross member 360, a busbar cover 362 located between the longitudinal busbar 361 and the pack cover 500 to cover the longitudinal busbar 361, and a connector 363 connected with a separate cable.

The third cover body 423, the fourth cover body 424, and the longitudinal cover body 425 may cover the busbar cover 362. The third cover body 423 and the fourth cover body 424 may be located between the busbar cover 362 and the pack cover 500 to cover the busbar cover 362. The longitudinal cover body 425 may be located between the busbar cover 362 and the connector 363 to cover the busbar cover 362.

According to this example structure, the first partition wall member 400a may prevent a fire from spreading from the battery module 200 to the longitudinal busbar 361, the busbar cover 362, and the connector 363, and thus safety may be improved.

The partition wall body 410, the first, second, third, and fourth cover bodies 421, 422, 423, and 424 of the cover body 420, and the longitudinal cover body 425 described above may be formed of MICA. However, without being limited thereto, the partition wall body 410, the first to fourth cover bodies 421, 422, 423, and 424 of the cover body 420, and the longitudinal cover body 425 may be formed of a material having insulation and heat resistance.

Accordingly, as illustrated in FIG. 8, the first partition wall member 400a may prevent heat transfer between the battery modules 200 spaced apart (e.g., from each other) in the first direction (the X direction or the direction opposite to the X direction) and may prevent foreign matter resulting from a fire in the battery modules 200 from causing a short circuit (e.g., phenomenon) between the busbar 121 and other components (e.g., adjacent) to the busbar 121.

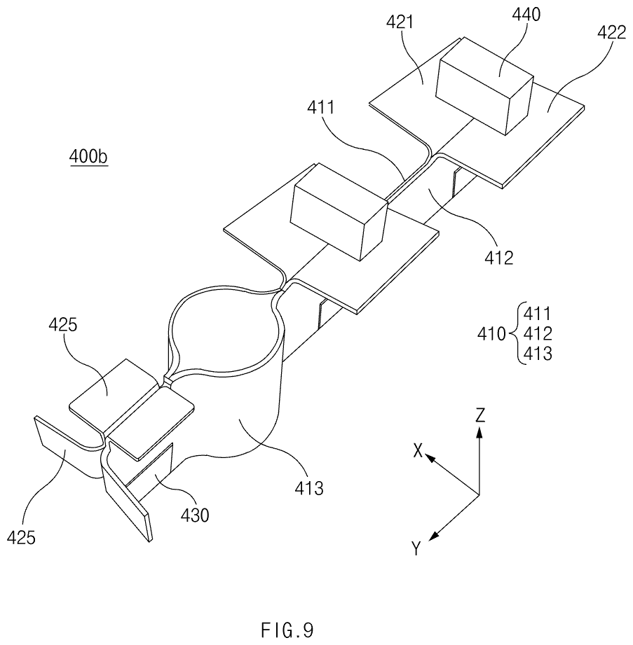

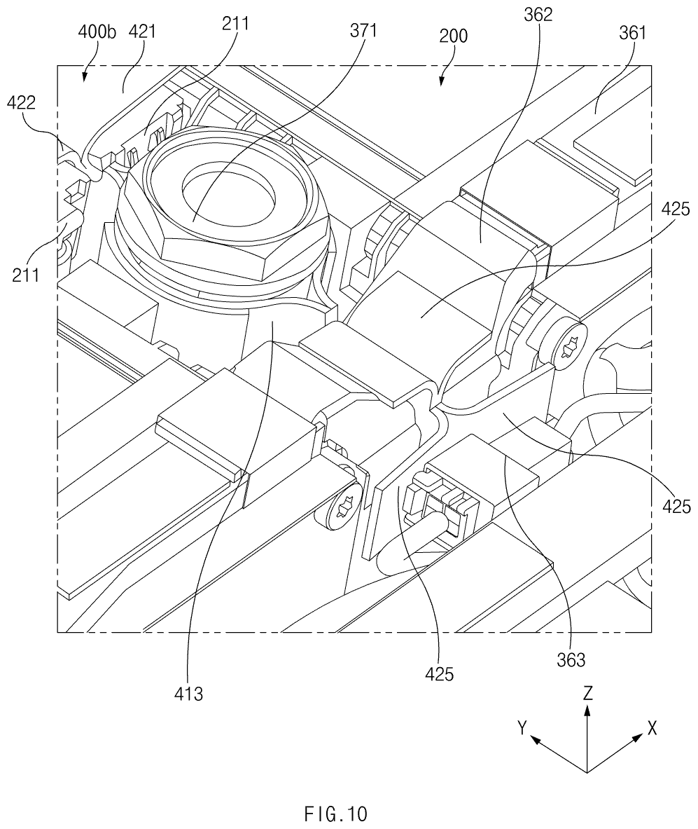

FIG. 9 is a perspective view of the second partition wall member according to an example embodiment of the present disclosure. FIG. 10 is an enlarged perspective view of a pair of battery modules and the first partition wall member according to an example embodiment of the present disclosure.

Referring to FIGS. 9 and 10, the second partition wall member 400b may have a length shorter than the (e.g., maximum) length of the first partition wall member 400a in the lengthwise direction.

The second partition wall member 400b may be a partition wall member 400 disposed on one side of the longitudinal cross member 360 in the second direction (the Y direction).

The second partition wall member 400b may include a partition wall body 410 extending (e.g., through) between the pair of battery modules 200 spaced apart (e.g., from each other) in the first direction (the X direction or the direction opposite to the X direction), and a first cover body 421 and a second cover body 422 bent from one end of the partition wall body 410 that faces toward one side in the third direction (the Z direction).

Unlike the first partition wall member 400a, the second partition wall member 400b may not have the third cover body 423 and the fourth cover body 424.

The second partition wall member 400b may have a buffer pad 430 and a sealing pad 440.

The partition wall body 410 of the second partition wall member 400b may include a pair of guide member covers 413. The pair of guide member covers 413 may be bent from a first partition wall body 411 and a second partition wall body 412 in opposite directions. The pair of guide member covers 413 may have a curvature to cover the fixed guide member 371.

The second partition wall member 400b may include a longitudinal cover body 425 extending from one end of the partition wall body 410 that faces toward the longitudinal cross member 360. Unlike the longitudinal cover body 425 of the first partition wall member 400a, the longitudinal cover body 425 of the second partition wall member 400b may include four longitudinal cover bodies 425. The longitudinal cover body 425 of the second partition wall member 400b may also be formed on one side of the second partition wall member 400b adjacent to the longitudinal cross member 360.

In an example embodiment, the longitudinal cover body 425 of the second partition wall member 400b may include four longitudinal cover bodies 425. Among the four longitudinal cover bodies 425, one pair of longitudinal cover bodies 425 may be bent from the first partition wall body 411, and another (e.g., the other) pair of longitudinal cover bodies 425 may be bent from the second partition wall body 412.

Among the four longitudinal cover bodies 425, one pair of longitudinal cover bodies 425 may be located between the busbar cover 362 and the pack cover 500 to cover the busbar cover 362, and the other pair of longitudinal cover bodies 425 may be located between the busbar cover 362 and the connector 363 to cover the busbar cover 362.

According to this example structure, the second partition wall member 400b may prevent a fire from spreading from the battery module 200 to the longitudinal busbar 361, the busbar cover 362, and the connector 363, and thus safety may be improved.

In an example embodiment, the partition wall body 410, the first and second cover bodies 421 and 422 of the cover body 420, and the longitudinal cover body 425 described herein may be formed of MICA. In another example embodiment, without being limited thereto, the partition wall body 410, the first and second cover bodies 421 and 422 of the cover body 420, and the longitudinal cover body 425 may be formed of a material having insulation and heat resistance.

Accordingly, the second partition wall member 400b may prevent heat transfer between the battery modules 200 spaced apart (e.g., from each other) in the first direction (the X direction or the direction opposite to the X direction) and may prevent foreign matter resulting from a fire in the battery modules 200 from causing a short circuit (e.g., phenomenon) between the busbar 121 and other components adjacent to the busbar 121.

For the shape or material of a structure (e.g., other than the structure of the second partition wall member 400b described above), the description of the shape or material of the structure of the first partition wall member 400a is provided.

According to the present disclosure, the partition wall member may cover the space between the busbar and the pack cover 500. Accordingly, a short circuit (e.g., phenomenon) between the busbar and the other components adjacent to the busbar may be prevented.

The partition wall member may be disposed between the pair of battery modules. Accordingly, heat transfer between the pair of battery modules separated (e.g., from each other) by the partition wall member may be prevented, and thus thermal runaway in the battery pack may be prevented.

The partition wall member may cover the space between the busbar cover and the pack cover 500 and may cover the space between the busbar cover and the connector. Accordingly, thermal runaway in the battery pack may be prevented.

The buffer pad of the partition wall member may fix (e.g., provide) the separation distance between the battery module and the partition wall body. Accordingly, the structural stability of the battery pack may be improved.

The sealing pad of the partition wall member may seal the space between the pack cover 500 and the cover body. Accordingly, even though vibration is applied to the battery pack, noise may be reduced, and the structural stability of the battery pack may be improved.

The angle between the partition wall body and the cover body may be an obtuse angle, and thus the productivity of the partition wall member may be improved.

In addition, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure.

Therefore, the example embodiments herein provide the scope of the present disclosure, but are not intended to limit the spirit and scope of the present disclosure. The scope of the present disclosure should be construed in view of the accompanying claims, and the technical ideas within the scope equivalent to the claims should be included in the scope of the present disclosure.

What is claimed is:

1. A battery pack comprising:
a pair of battery modules including
a first battery module including a first battery cell and a first busbar electrically connected to the first battery cell, and
a second battery module including a second battery cell and a second busbar electrically connected to the second battery cell;
a pack housing configured to cover portions of peripheries of the first battery module and the second battery module;
a pack cover coupled to the pack housing and configured to cover a side of the first battery module and the second battery module; and
a partition wall member disposed between the first battery module and the second battery module, the partition wall member is disposed between the pack cover and the first busbar to cover the first busbar, and the partition wall member is disposed between the pack cover and the second busbar to cover the second busbar.

2. The battery pack of claim 1, wherein the partition wall member includes:
a partition wall body provided between the first busbar and the second busbar, and
a cover body configured to extend from the partition wall body and cover the first busbar and the second busbar.

3. The battery pack of claim 2, wherein the cover body is disposed between the first busbar and the second busbar and the pack cover.

4. The battery pack of claim 2, wherein the cover body includes a pair of cover bodies including a first cover body and a second cover body,
wherein the partition wall body includes a first partition wall body connected with the first cover body and a second partition wall body connected with the second cover body.

5. The battery pack of claim 4, wherein the first partition wall body and the second partition wall body are attached.

6. The battery pack of claim 4, wherein the partition wall body extends in a direction between the first battery module and the second battery module,
wherein the first cover body is a plurality of first cover bodies and the second cover body is a plurality of second cover bodies, and
wherein the plurality of first cover bodies are spaced apart in the direction, and the plurality of second cover bodies are spaced apart in the direction.

7. The battery pack of claim 2, wherein an angle between the partition wall body and the cover body is an obtuse angle.

8. The battery pack of claim 2, wherein an angle between the partition wall body and the cover body is 95 degrees.

9. The battery pack of claim 2, wherein
the first battery module further includes a first sensing assembly formed on a side in a lengthwise direction of the first battery cell, and
the second battery module further includes a second sensing assembly formed on a side in a lengthwise direction of the second battery cell.

10. The battery pack of claim 9,
wherein the partition wall member further includes a buffer pad attached to a surface of the partition wall body configured to face at least one of the first sensing assembly or the second sensing assembly.

11. The battery pack of claim 10, wherein the buffer pad includes rubber.

12. The battery pack of claim 3, wherein the partition wall member further includes a sealing pad disposed between the cover body and the pack cover.

13. The battery pack of claim 12, wherein the sealing pad is configured to seal a space between the cover body and the pack cover.

14. The battery pack of claim 12, wherein the sealing pad includes rubber.

15. The battery pack of claim 1, wherein the pack housing includes a base plate configured to support the first battery module and the second battery module and a cross member supported by the base plate and configured to extend between the first battery module and the second battery module, and
wherein the partition wall member is supported by the cross member.

16. The battery pack of claim 15, wherein the cross member includes:
a longitudinal cross member configured to extend in a lengthwise direction of the battery pack; and
a transverse cross member configured to extend in a direction crossing the longitudinal cross member, and
wherein the partition wall member is supported by the transverse cross member.

17. The battery pack of claim 16, further comprising:
a fixing member configured to couple the base plate and the pack cover,
wherein the pack housing further includes a fixed guide member through which the fixing member passes, and
wherein the partition wall member includes a cover body provided between the first busbar and the second busbar, the cover body includes a guide member cover with a curvature to cover the fixed guide member.

18. The battery pack of claim 16, further comprising:
a longitudinal busbar disposed parallel to the longitudinal cross member, and
a busbar cover between the longitudinal busbar and the pack cover to cover the longitudinal busbar,
wherein the partition wall member includes:
a partition wall body provided between the first busbar and the second busbar, and
a longitudinal cover body configured to extend from an end of the partition wall body in a lengthwise direction and cover the busbar cover.

19. The battery pack of claim 2, wherein the partition wall body is formed of MICA.

20. The battery pack of claim 2, wherein the cover body is formed of MICA.
